(19) United States
(12) Patent Application Publication
(10) Pub. No.: US 2025/0304005 A1
(43) Pub. Date: Oct. 2, 2025

(54) Assigning a User to a Motor Vehicle

(71) Applicant: Bayerische Motoren Werke Aktiengesellschaft, Muenchen (DE)

(72) Inventors: Thorsten KNOTT, Tuntenhausen (DE); Tomas Urban, Holzkirchen (DE)

(21) Appl. No.: 19/064,879

(22) Filed: Feb. 27, 2025

(30) Foreign Application Priority Data
Mar. 27, 2024 (DE) 10 2024 108 855.9

(51) Int. Cl. B60R 25/24

(52) U.S. Cl. CPC B60R 25/24; B60R 2325/101

(57) ABSTRACT

A method for establishing an assignment between a security device of a motor vehicle and a user of a mobile device, wherein the motor vehicle has an interaction device communicatively connected to the mobile device, includes the steps of transmitting a first identification assigned to the security device from the motor vehicle to the mobile device; deter-mining a second identification assigned to a user of the mobile device; transmitting the first and the second identification from the mobile device to an external location; determining that the first identification and the second identification are as-signed to the same motor vehicle; and transmitting a release of an assignment of the user of the mobile device to the security device.

### CROSS REFERENCE TO RELATED APPLICATION

This application claims priority under 35 U.S.C. § 119 from German Patent Application No. 10 2024 108 855.9, filed Mar. 27, 2024, the entire disclosure of which is herein expressly incorporated by reference.

### BACKGROUND AND SUMMARY

The present invention relates to the assignment of a user to a motor vehicle. In particular, the invention relates to the coupling of an owner with the motor vehicle in the context of a digital safeguard of the motor vehicle.

A motor vehicle can be secured by means of a digital car key (DCK). A user can load a digital vehicle key on a mobile device and control a security function of the motor vehicle using this vehicle key. The security function can comprise a vehicle immobilizer or a central locking function. Digital vehicle keys can be created or validated by a marked user of the motor vehicle, typically an owner. Predetermined authorizations for using the motor vehicle can thus be delegated to other people.

One possibility for assigning a user as an owner to a motor vehicle is described in detail, for example, by the Car Connectivity Consortium (CCC). If such a logical assignment was carried out, further functions can thus be used between a mobile device of the user and the motor vehicle. For example, the motor vehicle can comprise an interaction device, which can be coupled with the mobile device in a communicative connection, so that an interaction with the mobile device can take place via the interaction device of the motor vehicle.

One object underlying the present invention is to provide a technology for assigning a person to a motor vehicle using an already existing communication connection of a mobile device of the user to an interaction device of the motor vehicle. The invention achieves this object by means of the subjects of the independent claims. Dependent claims specify preferred embodiments.

According to a first aspect of the present invention, a method for establishing an assignment between a security device of a motor vehicle and a user of a mobile device, wherein the motor vehicle comprises an interaction device communicatively connected to the mobile device, comprises the steps of transmitting a first identification assigned to the security device from the motor vehicle to the mobile device; determining a second identification assigned to a user of the mobile device; transmitting the first and the second identification from the mobile device to an external point; determining that the first identification and the second identification are assigned to the same motor vehicle; and transmitting a release of an assignment of the user of the mobile device to the security device.

An assignment described herein can also be called a coupling and describes establishing a logical connection, here in particular between the user and the security device or the motor vehicle. A completed assignment or coupling can be a condition for meeting a requirement of one side to the other, to control a security function of the motor vehicle. Establishing such an assignment is also known under the designation “pairing”. In the mentioned technical specification of the CCC, the assignment of a user to a motor vehicle or its security device is designated as “owner pairing”. The assignment can take place in an arbitrary direction on one side or preferably two sides.

With the aid of the method, an already existing communicative connection between the mobile device and the interaction device can be used to create an assignment between the person and the security device. This procedure can be carried out easily and rapidly. The method can be carried out securely and can prevent a misuse by an unauthorized person. The method can run here with a high degree of automation, so that, for example, the input of an identification number by the person is not necessary.

A user can decide initially to only couple their mobile device with the interaction device without installing or using a digital vehicle key, using which the security device can be controlled. A communicative connection established by the coupling can enable an input or output of the mobile device at the person via the interaction device. By using such a communicative connection, according to the method, the first identification can be transmitted from the motor vehicle to the mobile device without requiring an intervention of the user. The first identification can thus be transmitted securely to the mobile device in an improved manner. An assignment of the user to the security device building thereon can be protected against misuse in an improved manner in this way.

The security device is preferably configured to control a use of the motor vehicle based on a digital vehicle key. The digital vehicle key preferably operates according to the specifications of the Car Connectivity Consortium, as are published, for example, in the technical specification “Digital Key release”. The security device can control a predetermined security function onboard the motor vehicle. The security function can control an access to an interior of the motor vehicle and can comprise, for example, unlocking a door, a window, or a hatch. The security function can also control a usage of a vehicle function and comprise, for example, the release of a vehicle immobilizer or a steering wheel lock.

To use the security function, a user can place their digital vehicle key on a mobile device. The mobile device can only access the digital vehicle key after the user has authenticated themselves with respect to the mobile device, for example, by presenting a biometric feature or by inputting a secret. If the mobile device approaches the motor vehicle, a digital communication connection can be established on which a mutual authentication takes place between the mobile device and the security device based on an asymmetrical cryptographic method. At the same time, a request to use a predetermined security function can be transmitted from the mobile device to the security device. The function sought can be released on the part of the security device if its usage is assigned to the presented digital vehicle key.

The assignment between the user and the security device can authorize the user to configure an authorization to use the motor vehicle in the security device. In particular, the user can be authorized to create or sign a digital vehicle key for another person, so that the created vehicle key can be used to control a predetermined security function of the motor vehicle. The present method preferably comprises the assignment of a marked user to the motor vehicle or the security device. Such a user is also designated as the owner in the technical CCC specification “Digital Key Release 3”, Version 1.2.2. Another user, whose assigned digital vehicle key is signed by the owner, is designated in contrast as a user. An owner can grant the authorization for the creation or signature of a further vehicle key to a user.

The first identification preferably relates to a unique identifier which is assigned to the security device. This identifier can be applied to the security device in the context of the production of the motor vehicle. Identifications of security devices are preferably distributed from a central location, so that, on the one hand, it is ensured that no collision takes place and, on the other hand, which safety device is assigned to which motor vehicle can be saved.

The second identification is preferably assigned to an application running on the mobile device. It is furthermore preferred in this case for the application to be assigned to the user of the mobile device. To carry out the method, it can be necessary for the mentioned application to be installed on the mobile device. In one embodiment, it is checked whether the application is installed on the mobile device. If this is not the case, the method can be terminated at this point. In one embodiment, the user of the mobile device can be assisted in installing the application. The application can be assigned to the user in the context of the installation.

An assignment of the user to the second identification can be established based on an authentication of the user with respect to the mobile device. The mobile device can comprise an operating system which controls an installation of applications. The application can be installed only if the user has previously authenticated themselves with respect to the operating system. The authentication can be carried out, for example, by presenting a biometric feature or by inputting a predetermined secret. An assignment of the user to the application can take place based on the completed authentication.

According to a further embodiment, the assignment of the user to the security device is not released if another user is already coupled with the security device. A level of protection against misuse can be further increased in this way. In addition, a constellation can be avoided in which multiple users are assigned as owners to the motor vehicle simultaneously.

In a further preferred embodiment, a notification of the user of the mobile device is transmitted to the external location. The assignment of the user to the security device can then only be released if the user corresponds to a user assigned to the motor vehicle. It can thus additionally be established whether a legal status of the user of the mobile device corresponds to a predetermined status with respect to the motor vehicle. In particular, it can be checked that the user is the owner of the motor vehicle. Establishing the communicative connection between mobile device and interaction device preferably enables an interaction of the user with the mobile device by means of the interaction device. An output of the mobile device can thus be transmitted by means of the interaction device to the user or an input of the user can be transmitted by means of the interaction device to the mobile device. The output can take place optically or acoustically.

An input of the user preferably usually takes place acoustically or haptically. Other interaction channels can also be used. In a particularly preferred embodiment, the mobile device comprises a first touch-sensitive display screen and the interaction device of the motor vehicle comprises a second one. The second display screen can be coupled to the mobile device in such a way that the user controls the mobile device in a familiar manner via the second touch-sensitive display screen. Optical contents of the display screens can be synchronized or reproduced in this case. Such technologies are known under the names “Apple Car Play” or “Android Auto”.

According to a further aspect of the present invention, a mobile device comprises a first wireless communication device for communication with a motor vehicle; a second communication device for communication with an external location; and a processing device. The processing device is configured here in particular to receive a first identification, which is assigned to a security device of the motor vehicle, via the first wireless communication device; to determine a second identification which is assigned to a user of the mobile device; to transmit the first and the second identification to a predetermined external point; to receive a release for the assignment of a user of the mobile device to a security device of the motor vehicle; and to create the assignment to the security device of the motor vehicle.

The mobile device can furthermore be configured to check an authentication of a user. A user can be authenticated, for example, based on a biometric feature or by knowing a predetermined secret. A multifactor authentication (MFA) is also possible.

According to still a further aspect of the present invention, a control device, which is also referred to herein as the location external to the motor vehicle, comprises a communication device for communication with a mobile device and a processing device. The processing device is configured here to receive from a mobile device a first identification, which is assigned to a security device of a motor vehicle coupled with the mobile device, and a second identification, which is assigned to a user of the mobile device; and to transmit a release for the assignment of the user to the security device to the mobile device if the first and the second identification are assigned to the same motor vehicle.

According to still another aspect of the present invention, a control device for a motor vehicle comprises a security device, an interaction device, and a wireless communication device. The control device is configured here to couple the interaction device via the communication device with a mobile device; to transmit a first identification assigned to the security device to the mobile device; and to create an assignment of a user of the mobile device to the security device after a release for the assignment has been received.

A mobile device described herein, an external location described herein, and a control device described herein can each be configured to partially carry out a method described herein. The mobile device, the external location, or the control device can comprise an electronically embodied processing device for this purpose, which comprises, for example, an integrated circuit, a programmable logic component, or a programmable microcomputer. The method can be implemented in the form of a configuration or as a computer program product having program code means for the processing device. The configuration or the computer program product can be stored on a computer-readable data carrier. Features or advantages of the method can be transferred to one of the mentioned devices or vice versa. In a corresponding manner, features or advantages can be transferred among the devices.

According to still another aspect of the present invention, a motor vehicle comprises a control device described herein. The motor vehicle can comprise, for example, a motorcycle or a passenger vehicle. In further embodiments, the motor vehicle can also comprise, for example, a truck or a bus.

According to yet another aspect of the present invention, a system comprises a motor vehicle described herein, a control device described herein, and a mobile device described herein. The system is preferably configured to carry out a method described herein.

The invention will now be described in more detail with reference to the appended drawings, in which:

### BRIEF DESCRIPTION OF THE DRAWINGS

FIG. 1 illustrates a system; and

FIG. 2 illustrates a flow chart of a method.

### DETAILED DESCRIPTION OF THE DRAWINGS

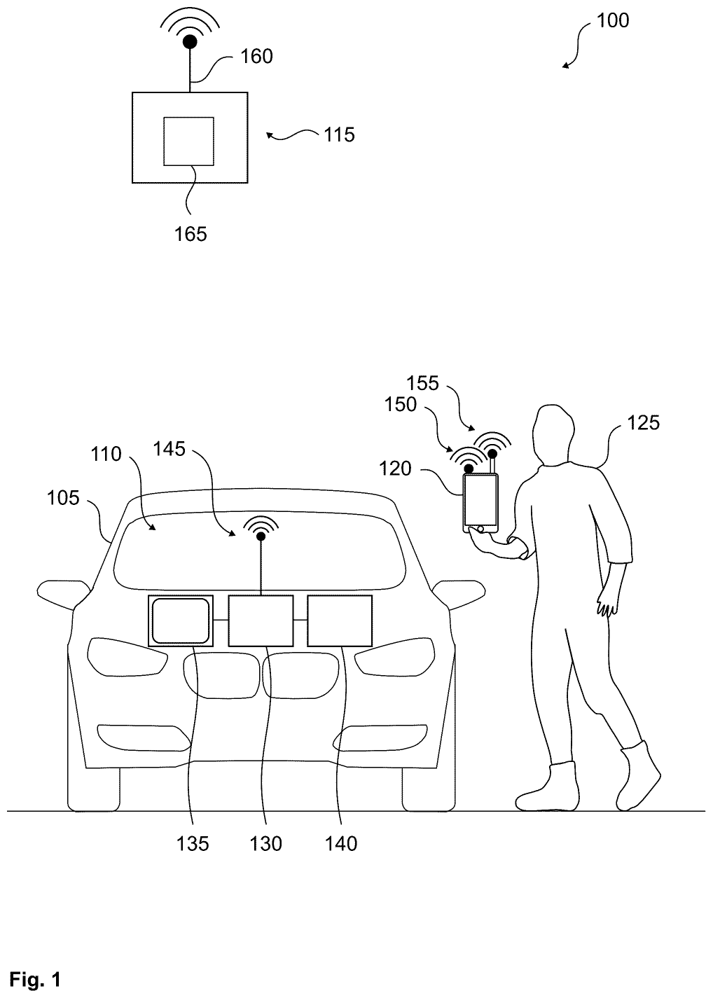

FIG. 1 shows a schematic representation of an exemplary system 100. A control device 110 is provided on board a motor vehicle 105. An external location 115 is located outside the motor vehicle 105. In addition, a mobile device 120 is provided, which is assigned to a user 125. The user 125 can comprise an arbitrary person; for the purposes of the following explanations, the user 125 can be an owner of the motor vehicle 105 or a person similarly relevant for the motor vehicle 105. The system 100 preferably comprises the control device 110, the external location 115, and the mobile device 120.

The control device 110 on board the motor vehicle 105 preferably comprises a processing device 130, an interaction device 135, a security device 140, and a communication device 145. The interaction device 135 is configured to enable an interaction with the user 125. For this purpose, the interaction device 135 can comprise a microphone, a loudspeaker, and/or a display screen, preferably a touch-sensitive display screen (touchscreen). In an exemplary embodiment, the interaction device 135 is attached in a center console of the motor vehicle 105, so that it can be used by people in a first row of seats of the motor vehicle 105.

The security device 140 is configured to control a security function of the motor vehicle 105. For this purpose, the security device 140 can control a wireless communication with a mobile device 120 and carry out a two-sided authentication based on an asymmetrical cryptographic method. The communication typically takes place by means of Bluetooth (BT) or Bluetooth low energy (BLE), for which purpose the security device 140 preferably comprises a separate communication device (not shown).

The communication device 145 is configured to establish a wireless communication connection with the mobile device 120. This communication can also take place via BT or BLE and is configured to transmit interaction data between the interaction device 135 and the mobile device 120. The control device 110 can also be assigned multiple communication devices 145. Establishing the communication connection can comprise an exchange of authentication information. The communication device 145 and the mobile device 120 can thus be coupled (paired) with one another. A meeting can be established for the data exchange between the devices 120, 155, for which purpose the devices 120, 145 have to be located in communication range. In the scope of this invention, a communication connection established once between the devices 120, 145 is assumed, which permits a communication as needed without requiring a further interaction of the user 125. If necessary, establishing or ending a meeting can take place transparently for this purpose.

Establishing the wireless communication connection via Bluetooth connection can also be called coupling; such coupling is distinguished, however, from coupling described herein in the sense of an assignment between the motor vehicle 105 or the security device 140 and the user 125 or the mobile device 120 assigned to them.

The mobile device 120 comprises a first communication device 150 for communication with the motor vehicle 105 and a second communication device 155 for communication with the external location 115. The second communication device 155 can comprise a mobile wireless interface. A part of the communication connection between the mobile device 120 and the external location 115 can also occur in a wired manner.

The external location 115 preferably comprises a communication device 160 and a processing device 165. A data memory is optionally provided to save assignment information. In a further embodiment, the external location 115 comprises an interface to a further control device, via which assignment information can be acquired.

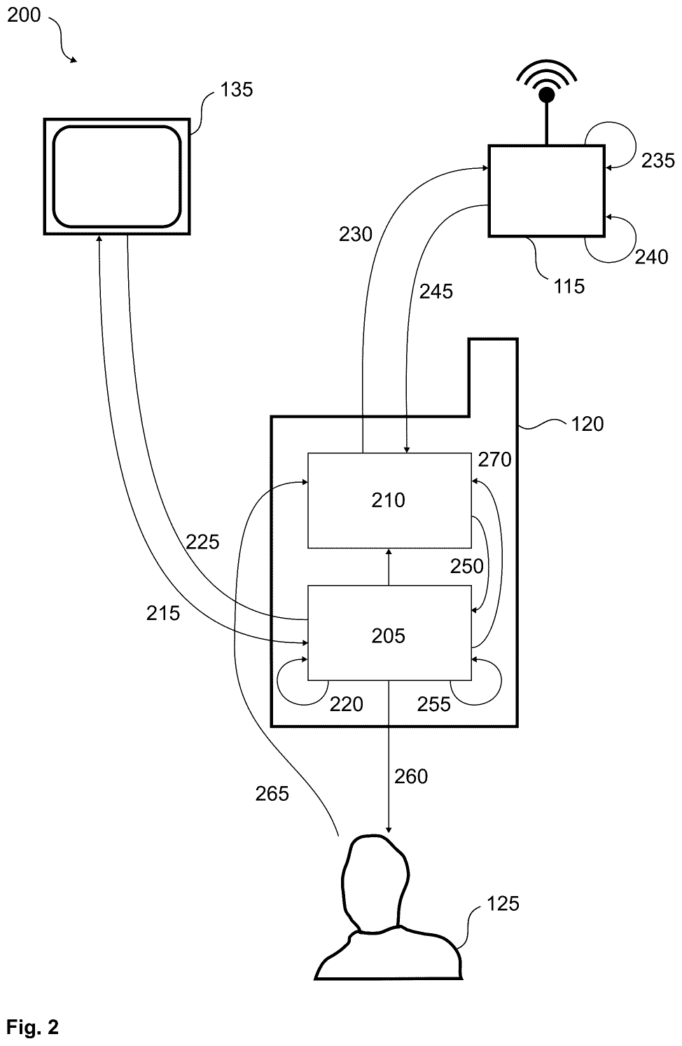

FIG. 2 shows a schematic flow chart of a method 200 for coupling a user 125 with a motor vehicle 105. Only the interaction device 135 is shown of the control device 110 on board the motor vehicle 105. The mobile device 120 is shown in abstract form; in the present case, it comprises an operating system 205 and an application 210 which run on hardware of the mobile device 120. It is to be noted that all steps of the method 200 described hereinafter do not necessarily have to be carried out to achieve the goal according to the invention. Moreover, some method steps can also be carried out in a different sequence.

In a step 215, a communicative connection is established between the mobile device 120 and the interaction device 135. This coupling preferably takes place based on a Bluetooth data connection via the communication device 145. A wireless communication connection can thus be established between the mobile device 120 and the interaction device 135.

If the user 125 decides to perform an assignment of their person or the mobile device 120 assigned to them to the motor vehicle 105 or to the security device 140 to use functions of the digital vehicle key, they can express a corresponding desire, for example, by input at the interaction device 135 or at the mobile device 120. In a step 220, it can be checked whether the application 210 is already correctly installed on the mobile device 120 and is possibly also initialized or personalized. If this is not the case, the user 125 can be requested to install the application 210 from a matching repository on the mobile device 120. The installation can require an authentication of the user 125 with respect to the operating system 205. A user identification (user ID) can be assigned to the user 125, which they have to use for the authentication with respect to the application 210. The authentication can be carried out by means of a function of the operating system 205. In addition, to use the application 210, it can be necessary for the user 125 to register at a service under their user identification.

In a step 225, a first identification of the security device 140 can be transmitted via the existing communication connection to the mobile device 120. The first identification is unique and is assigned to the security device 140. However, it is not identical with a vehicle identification number, which can be used for the identification of the motor vehicle 105.

In a step 230, the first identification can be transmitted together with the second identification of the user 125 to the external location 115.

In a step 235, it can be checked based on the first identification whether an assignment to a person 125 is already present. If this is the case, a corresponding error message can be generated and transmitted to the mobile device 120. A further assignment cannot take place in this case.

In a step 240, it is checked whether the security device 140 and the user 125 are assigned to the same motor vehicle 105. The motor vehicle 105 can be specified by its vehicle identification number (VIN). The assignments can be taken from a data memory or a directory service.

If it should be determined that the two identifications are assigned to different motor vehicles, the method 200 can thus fail. An assignment of the person 125 to the security device 140 then cannot take place. A corresponding error message can optionally be transmitted from the external location 115 to the mobile device 120.

Furthermore, it can be checked whether an owner assigned to the motor vehicle 105 or its VIN corresponds to the user 125. For this purpose, the user 125 can be identified based on the second identification. The assignment of an owner to a motor vehicle 105 can be stored, for example, on the part of a service of a producer of the motor vehicle 105 or a national agency.

In a step 245, a release for the assignment of the user 125 to the security device 140 can be transmitted to the application 210 on the mobile device 120.

In a step 250, the application 210 can forward the release to the operating system 205. In a step 255, the operating system 205 can check whether the current user 125 of the mobile device 120 or the application 210 corresponds to the user who was determined by the external location 115 as the owner of the motor vehicle 105. A corresponding specification can have been transmitted from the external location 115 in the context of the release in step 245. If the user 125 should not correspond to the owner, the method 200 can end at this point. An explanatory message can optionally be output to the user 125.

In a step 260, the user 125 can be prompted to declare their consent to the assignment to the security device 140. For this purpose, the user 125 can actuate, for example, a corresponding switch surface of the application 210. In a step 265, the consent of the user 125 can be captured.

In a step 270, the assignment of the user 125 to the security device 140 on board the motor vehicle 105 can be carried out. For this purpose, information which has been collected in the scope of the method 200 can be transmitted to the security device 140. The coupling can take place based on a digital vehicle key which is deposited on the mobile device 120. The special status of an owner can be assigned to this vehicle key on the part of the security device 140. Generating or signing the digital vehicle key for the user 125 on the mobile device 120 can take place in a known manner according to the specifications of the CCC.

### REFERENCE NUMERALS

100 system
105 motor vehicle
110 control device
115 external location
120 mobile device
125 user
130 processing device
135 interaction device
140 security device
145 communication device
150 first communication device
155 second communication device
160 communication device
165 processing device
200 method
205 operating system
210 application
215 establish communication connection to interaction device
220 application installed?
225 transmit first identification to mobile device
230 transmit first and second identification to external location
235 existing assignment of the security device to a user?
240 first and second identification assigned to the same motor vehicle?
245 transmit release
250 forward release
255 user corresponds to owner?
260 input prompt
265 capture consent to assignment
270 assignment

What is claimed is:

1. A method for establishing an assignment between a security device of a motor vehicle and a user of a mobile device, wherein the motor vehicle includes an interaction device communicatively connected to the mobile device, the method comprising:
transmitting a first identification assigned to the security device from the motor vehicle to the mobile device;
determining a second identification assigned to a user of the mobile device;
transmitting the first identification and the second identification from the mobile device to an external location;
determining that the first identification and the second identification are assigned to the motor vehicle; and
transmitting a release of an assignment of the user of the mobile device to the security device.

2. The method according to claim 1, wherein the security device is configured to control a use of the motor vehicle based on a digital vehicle key.

3. The method according to claim 1, wherein the user is coupled with the security device and is authorized to configure an authorization to use the motor vehicle in the security device.

4. The method according to claim 2, wherein the user is coupled with the security device and is authorized to configure an authorization to use the motor vehicle in the security device.

5. The method according to claim 1, wherein the second identification is assigned to an application running on the mobile device, and the application is assigned to the user.

6. The method according to claim 2, wherein the second identification is assigned to an application running on the mobile device, and the application is assigned to the user.

7. The method according to claim 5, wherein it is determined that the application is installed on the mobile device.

8. The method according to claim 1, wherein the assignment of the user to the second identification is established based on an authentication of the user with respect to the mobile device.

9. The method according to claim 2, wherein the assignment of the user to the second identification is established based on an authentication of the user with respect to the mobile device.

10. The method according to claim 1, wherein the assignment is not released if another user is already coupled with the security device.

11. The method according to claim 1, wherein a notification of the user of the mobile device is transmitted to the external location, and the assignment is only released if the user corresponds to a user assigned to the motor vehicle.

12. The method according to claim 2, wherein a notification of the user of the mobile device is transmitted to the external location, and the assignment is only released if the user corresponds to a user assigned to the motor vehicle.

13. The method according to claim 1, wherein the communication connection of the mobile device with the interaction device enables an interaction of the user with the mobile device via the interaction device.

14. The method according to claim 2, wherein the communication connection of the mobile device with the interaction device enables an interaction of the user with the mobile device via the interaction device.

15. A mobile device comprising:
a first wireless communication device for communication with a motor vehicle;
a second wireless communication device for communication with an external location; and
a processing device, wherein the processing device is configured to:
receive a first identification, which is assigned to a security device of the motor vehicle;
determine a second identification, which is assigned to a user of the mobile device;
transmit the first identification and the second identification to a predetermined external location;
receive a release for the assignment of the user of the mobile device to the security device of the motor vehicle; and
create the assignment to the security device of the motor vehicle.

16. A control device comprising a communication device for communication with a mobile device and a processing device, wherein the processing device is configured to receive from the mobile device a first identification, which is assigned to a security device of a motor vehicle coupled with the mobile device, and a second identification, which is assigned to the user of the mobile device; and to transmit a release for the assignment of the user to the security device to the mobile device if the first identification and the second identification are both assigned to the motor vehicle.

17. A control device for a motor vehicle, wherein the motor vehicle includes a security device, an interaction device, and a wireless communication device, wherein the control device is configured to:
communicatively connect the interaction device via the communication device with a mobile device;
transmit a first identification assigned to the security device to the mobile device; and
create an assignment of a user of the mobile device to the security device after a release for the assignment has been received.

18. A motor vehicle comprising a control device according to claim 17.

19. A system comprising:
a motor vehicle;
a control device; and
a mobile device according to claim 15.
